(19) United States
(12) Patent Application Publication
(10) Pub. No.: US 2012/0329591 A1
(43) Pub. Date: Dec. 27, 2012

(54) BELT FOR DRIVING SYSTEMS, IN PARTICULAR A BELT-LIKE TENSILE ELEMENT FOR ELEVATOR SYSTEMS, HAVING FIRE-INHIBITING PROPERTIES

(76) Inventors: Hubert Goeser, Dannenberg (DE); Thomas Winkler, Dannenberg (DE); Hugh J. O'Donnell, Longmeadow, MA (US); Stephan Brocke, Hamburg (DE)

(21) Appl. No.: 13/605,697

(22) Filed: Sep. 6, 2012

Related U.S. Application Data
(63) Continuation of application No. PCT/EP2010/063776, filed on Sep. 20, 2010.

(30) Foreign Application Priority Data
May 11, 2010 (DE) 10 2010 016 872.6

(51) Int. Cl. F16G 5/08; F16G 5/06

(52) U.S. Cl. 474/238; 474/264

(57) ABSTRACT

A belt for driving systems, including a belt body made of a polymeric material having elastic properties, which comprises a cover layer as a back of the belt and a foundation having a force-transmission zone, and, a tensile reinforcement embedded in the belt body. The belt body is made of at least two different materials A and B, namely: a first material A, which is provided with a fire-inhibiting additive and is used in the belt body everywhere the high mechanical properties are not required; and, a second material B, which contains little or none of a fire-inhibiting additive and is used in the area of the belt body that is subjected to great mechanical stress. The belt is used in particular as a tensile element for elevator systems.

### CROSS REFERENCE TO RELATED APPLICATIONS

This application is a continuation application of international patent application PCT/EP 2010/063776, filed Sep. 20, 2010, designating the United States and claiming priority from German application 10 2010 016 872.6, filed May 11, 2010, and the entire content of both applications is incorporated herein by reference.

### FIELD OF THE INVENTION

The present invention relates to a belt for drive engineering, composed at least of:
a belt structure made of a polymeric material with elastic properties, encompassing an outer layer as belt backing and a substructure with a force-transmission zone; and,
a tension-member system embedded in the belt structure.

### BACKGROUND OF THE INVENTION

Belts of this type are also termed force-transmission belts and can be flat belts, V-belts, V ribbed belts or toothed belts, or composite cables. In this connection, reference is particularly made to the following patent literature: DE 38 23 157 A1, U.S. Pat. No. 7,128,674, United States patent application publication 2008/0261739, DE 10 2007 062 285 A1, DE 10 2008 012 044 A1, U.S. Pat. No. 7,749,118 and United States patent application publication 2010/0240481, United States patent application publication 2008/0032837, U.S. Pat. No. 3,981,206, U.S. Pat. No. 5,417,618, and U.S. Pat. No. 6,491,598.

The elasticity of a belt is achieved in that the belt structure, and therefore the outer layer and the substructure, is/are composed of a polymeric material with elastic properties, and two groups of materials that may be mentioned in particular here are elastomers and thermoplastic elastomers. Elastomers based on a vulcanized rubber mixture comprising at least one rubber component and mixture ingredients are particularly important. The following are in particular used as rubber component: ethylene-propylene rubber (EPM), ethylene-propylene-diene rubber (EPDM), (partially) hydrogenated nitrile rubber (HNBR), fluoro rubber (FKM), natural rubber (NR), chloroprene rubber (CR), styrene-butadiene rubber (SBR), butadiene rubber (BR) or polyurethane (PU), and these may be unblended or blended with at least one further rubber component, in particular with one of the abovementioned types of rubber, for example in the form of an EPM/EPDM blend or SBR/BR blend. A particularly important material here is HNBR, EPM, EPDM, PU or an EPM/EPDM blend. The mixture ingredients encompass at least one crosslinking agent or one crosslinking agent system (crosslinking agent and accelerator). Further additional mixture ingredients are mostly a filler and/or a processing aid and/or a plasticizer and/or an antioxidant and optionally other additional materials, for example fibers for reinforcement purposes, and color pigments. In this connection, reference is made to the general prior art of rubber mixture technology.

The belt has an embedded tension-member system, formed from at least one tension member running in the longitudinal direction of the belt. A plurality of tension members mostly form a tension-member-system layer. Particular importance is attached here to a tension member which has a cord structure, and in this connection various materials are used in designs of the prior art. The significant types of material are: steel, polyamide (PA), aramid, polyester, glass fibers, carbon fibers, basalt, polyether ether ketone (PEEK), polyethylene terephthalate (PET), polybenzoxazole (PBO) and polyethylene-2,6-naphthalate (PEN). The preparation of the tension member moreover mostly uses an adhesive system, for example a resorcinol-formaldehyde latex (RFL), in order to provide long-term adhesion to the surrounding polymeric material.

Steel has now become a relatively unimportant material in continuous belts for vehicle construction. Tension members in particular used here are made of PA or PET or else in recent times of basalt.

However, when noncontinuous belts are used as tension element in elevator engineering—which is a central topic hereinafter—the high tensile force gives significant importance to steel as tension-member material, in particular in the form of steel cords. In relation to the prior art in this connection, reference is particularly made to the following patent literature: DE 10 2006 020 633 B3, DE 10 2008 018 191 A1, DE 10 2008 018 192 A1, DE 10 2008 037 537 A1, United States patent application publication 2011/0226562, EP 1 396 458 A2, U.S. Pat. No. 7,757,817 and United States patent application publication 2009/0166132, United States patent application publication 2002/0000346, and U.S. Pat. No. 6,739,433.

In particular the force-transmission zone of a belt is provided with an abrasion-resistant coating which also serves for noise reduction and can moreover have been rendered oil-resistant. Materials used here are a superposed flock, in particular taking the form of a cotton flock or aramid flock, a thin elastic polymer layer filled with fibers (for example, aramid fibers), a superposed textile, in particular taking the form of a woven or knitted material, or a foil (for example, PTFE foil) or a foil composition (for example, PA-PTFE foil). The woven material is particularly important here. The coatings mentioned here are mostly prepared in a manner that promotes adhesion on the side of contact with the belt structure, in particular with the substructure thereof, an example of a material used for this purpose being RFL.

A problem with belts of all types is that the polymeric material of the belt structure is very combustible. In the event of a fire, the entire belt-structure material would be consumed by combustion and sometimes also damage the tension-member system. These problems are particularly relevant to a belt-like tension element for elevator engineering, where the steel tension-element system can then be damaged. In any event, the elevator would no longer function correctly and would therefore no longer be safe.

### SUMMARY OF THE INVENTION

The object of the invention then consists in providing a belt, in particular a tension element for elevator engineering, where the belt-structure material is intended to be non-combustible or self-extinguishing, in such a way that a fire does not affect the entire belt, in particular the entire tension element, and specifically capability to function correctly is retained, in particular in the case of elevator systems.

The object is achieved in that the belt structure is composed of at least two different materials A and B, namely of:
a first material A which comprises a fire-retardant additive and which has been incorporated in the belt structure wherever there is no requirement for the high level of mechanical strength; and,
a second material B which has low, or no, content of a fire-retardant additive and which is used in the belt-structure region which is subject to the highest level of mechanical stress.

In particular in the case of the first material A, the mixture ingredients mentioned in the introduction for the polymeric material are supplemented by the fire-retardant additive.

The quantitative proportions applicable to the first material A and the second material B within the belt structure are preferably as follows:
first material A: from 40% by weight to 95% by weight, in particular from 60% by weight to 80% by weight
second material B: from 60% by weight to 5% by weight, in particular from 40% by weight to 20% by weight.

The following classes of substance are in particular used as fire-retardant additives:
melamine phosphate, melamine polyphosphate
melamine cyanurate
ammonium polyphosphate
halogenated organic compounds (for example, polytetrafluoroethylene)
organic phosphoric esters (for example, polyphosphoric diesters)
organic phosphonates, polyphosphonates
red phosphorus
metal hydroxides (for example, calcium hydroxide, magnesium hydroxide, aluminum hydroxide)
metal carbonates (for example, calcium carbonate, magnesium carbonate)
glass powder, quartz powder.

It is possible here to use a single class of substance, for example a melamine phosphate, or a two- or multicomponent system, for example a mixture of melamine phosphate and melamine cyanurate.

The additives here have been mixed in essence uniformly within the polymer matrix, in particular in the case of the first material A.

The quantitative proportion of the fire-retardant additive for the first material A is preferably from 5% by weight to 50% by weight, in particular from 10% by weight to 30% by weight.

The quantitative proportion of the fire-retardant additive for the second material B is in contrast preferably from 0% by weight to 5% by weight, in particular from 0 to 3% by weight. The focus of the fire-retardant properties is therefore exclusively on the first material A.

The outer layer of the belt, where there is no requirement for the high level of mechanical properties, comprises the first material A with its fire-retardant properties.

The substructure with its force-transmission zone, which is in contact with the traction pulley, is subject to the highest level of mechanical requirements, and in contrast the second material B, with no, or only a low level of, fire-retardant properties is therefore used here. The second material advantageously comprises no fire-retardant additives, since admixture of additives of this type can adversely affect the mechanical property profile of the polymeric material.

The tension-member-system region which also forms the transition region of outer layer and substructure can be in contact with the first material A and/or second material B, and in particular the following two variants are used here:
Incorporation of the second material B in the substructure is such that the second material B partially or completely sheaths the tension-member system. The immediate environment of the tension-member system therefore has no, or only a low level of, fire-retardant properties. A design using this type of material is likewise presented in more detail in conjunction with the example in FIG. 1.
Incorporation of the second material B in the substructure is such that the first material A partially or completely sheaths the tension-member system. The immediate environment of the tension-member system is likewise thus involved in the fire-retardant properties. A design using this type of material is likewise presented in more detail in conjunction with the example in FIG. 2.

In another possible design, the first material A forms the belt core and the second material B forms the belt shell. In particular here, the tension-member system has been embedded in the belt core with complete sheathing by the first material A. The immediate environment of the tension-member system is thus involved in the fire-retardant properties. It is preferable that the belt shell with the second material B completely surrounds the belt core. A design using this type of material is presented in more detail in conjunction with the example in FIG. 3.

It is mostly sufficient that the belt structure is composed exclusively of the two materials A and B, in particular in conjunction with the two abovementioned variants.

It can be advantageous, if the belt type and the position of the tension-member system are appropriate, to equip the belt structure additionally with an elastic intermediate layer with a third material C, where the tension-member system has been embedded within the intermediate layer. There can be a fire-retardant additive mixed into the intermediate layer, and reference is made here to the following example:

| | | Quantitative |
|---|---|---|
| Belt structure | | proportion of fire- |
| component | Type of material | retardant additive |
| Outer layer | first material A | 25% by weight |
| Substructure with | second material B | — |
| force-transmission | | |
| zone | | |
| Intermediate layer | third material C | 5% by weight |
| with embedded tension- | | |
| member system | | |

The concentration of the fire-retardant additive rises in the belt structure from the substructure, which is free from any fire-retardant additive, toward the outer layer.

The belt structure can additionally have at least one embedded layer. The layer is in particular composed of a textile material in the form of a woven or knitted material. The layer can also have been rendered fire-retardant in that by way of example the textile fibers have been prepared so as to be fire-retardant.

The outer layer and/or the force-transmission zone can equally additionally have a coating. A particular coating used is a superposed textile in the form of a woven or knitted material. The superposed woven material is particularly important here. The coating can likewise have been rendered fire-retardant, again in that by way of example the textile fibers have been prepared so as to be fire-retardant.

The belt is a flat belt, V-belt, V-ribbed belt or toothed belt, or as composite cable.

The belt of the invention is in particular used as tension element in elevator engineering, in particular with use of composite cables, or of a flat belt or toothed belt. In the event of a fire, the fire is not distributed by way of the tension element through the height of the entire elevator shaft. The tension element comprising these materials has very low flammability and mostly self-extinguishes after the fire has made very little progress.

The elevator retains some capability to function. Another advantage is that a tension element of this type cannot transmit a fire in a building from one storey to the next.

### BRIEF DESCRIPTION OF THE DRAWINGS

The invention will now be described with reference to the drawings wherein:

FIG. 1 shows a belt in the form of composite cables as tension element for elevator engineering, operating together with a profiled traction pulley;

FIG. 2 shows a belt in the form of a flat belt as tension element for elevator engineering, operating together with an unprofiled traction pulley; and,

FIG. 3 shows a belt in the form of a flat belt with belt core and belt shell as tension element for elevator engineering, operating together with an unprofiled traction pulley.

### DESCRIPTION OF THE PREFERRED EMBODIMENTS OF THE INVENTION

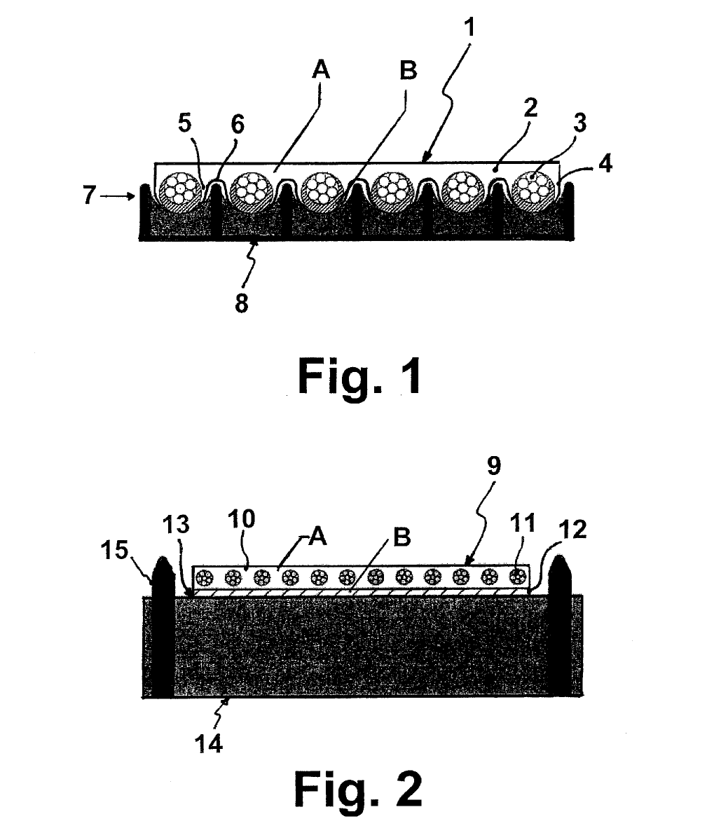

FIG. 1 shows a belt 1 as tension element for elevator engineering, and specifically in the form of composite cables with an outer layer 2 as belt backing, an embedded tension-member system 3 with a plurality of tension members in the form of steel cords running in a longitudinal direction and a substructure 4. The substructure 4 has a rib-and-groove structure, formed from ribs 5 and grooves 6. The steel cords of the tension-member system 3 here have been arranged respectively in essence within a rib 5. Finally, the substructure 4 encompasses the force-transmission zone 7, which corresponds to an appropriately profiled traction pulley 8. In respect of design details of the traction pulley 8, reference is made by way of example to the following two published specifications: DE 10 2008 037 537 A1 and United States patent application publication 2011/0226562.

The outer layer 2 and the substructure 4 form, as entire unit, the elastic belt structure which is also termed main structure, for example based on PU. The belt structure here is based on a first material A and a second material B. The first material A with a high proportion of a fire-retardant additive (for example, 25% by weight) here encompasses the entire outer layer 2, where there is no requirement for the high level of mechanical properties. The second material B, which has low (for example, 3% by weight), or no, content of a fire-retardant additive encompasses almost the entire substructure 4 with the force-transmission zone 7. That is where the belt structure is subject to the greatest mechanical load. The second material B here has been arranged within a rib 5 of the substructure 4, and at the same time almost sheaths the entire tension-member system 3.

FIG. 2 shows a belt 9 as tension element for elevator engineering, and specifically here in the form of a flat belt with an outer layer 10 as belt backing, an embedded tension-member system 11 with a plurality of tension members in the form of steel cords running longitudinally, and a substructure 12. The substructure 12 here is flat and encompasses the force-transmission zone 13, which corresponds to a traction pulley 14 with flanged rim 15. In respect of design details for the traction pulley 14, reference is made here by way of example to the published specification United States patent application publication 2002/0000346 A1.

The outer layer 10 and the substructure 12 here likewise form, as entire unit, the elastic belt structure, for example again based on PU. The belt structure here is composed of a first material A and a second material B. The first material A with a high proportion of a fire-retardant additive (for example, 25% by weight) here encompasses the entire outer layer 10 and the entire region of the tension-member system 11 which means that the first material A here completely sheaths all of the steel cords. The substructure 12 with the flat force-transmission zone 13 comprises the second material B, which has low (for example, 3% by weight), or no, content of a fire-retardant additive.

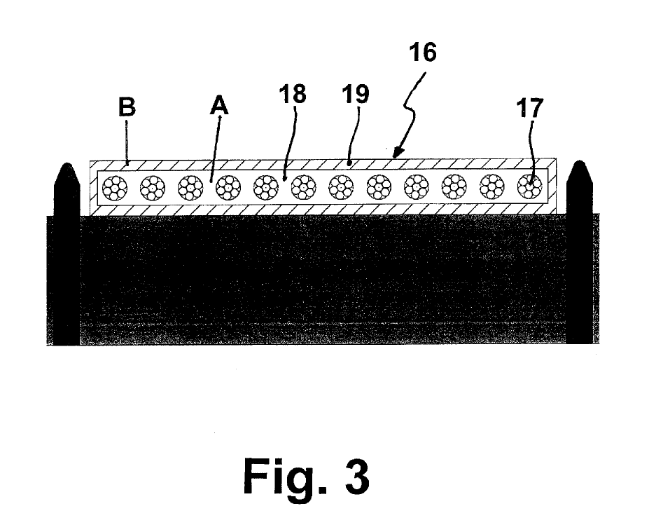

FIG. 3 shows a belt 16 as tension element for elevator engineering, and specifically in the form of a flat belt, as in example 2. The difference is that here the first material A forms the belt core 18 and the second material B forms the belt shell 19. The tension-member system 17 here has been embedded in the belt core 18 with complete sheathing by the first material A. The belt shell 19 completely surrounds the belt core 18. The first material A with a high proportion of a fire-retardant additive (for example, 25% by weight) therefore encompasses the entire belt core 18. In contrast, the entire belt shell 19 comprises the second material B, which has low (for example, 3% by weight), or no, content of afire-retardant additive. If, therefore, the belt shell 19 with the second material B is consumed by combustion at the sites exposed to a fire, the belt core 18 with the first material A then inhibits fire spread to the entire belt 16.

In respect of the traction pulley, reference is made to the examples in FIG. 2.

It is understood that the foregoing description is that of the preferred embodiments of the invention and that various changes and modifications may be made thereto without departing from the spirit and scope of the invention as defined in the appended claims.

### KEY (PART OF DESCRIPTION)

1 Belt as tension element in the form of composite cables
2 Outer layer in the form of belt backing
3 Tension-member system in the form of steel cords
4 Substructure
5 Ribs
6 Grooves
7 Force-transmission zone
8 Traction pulley
9 Belt as tension element in the form of a flat belt
10 Outer layer as belt backing
11 Tension-member system in the form of steel cords
12 Substructure
13 Force-transmission zone
14 Traction pulley
15 Edge flange
16 Belt as tension element in the form of a flat belt
17 Tension-member system in the form of steel cords
18 Belt core with embedded tension-member systems
19 Belt shell
A First material
B Second material

What is claimed is:

1. A belt for drive applications, comprising:
a belt structure made of a polymeric material having elastic properties, the belt structure encompassing an outer layer as belt backing and a substructure having a force-transmission zone; and,
a tension-member system embedded in the belt structure;
wherein the belt structure includes:
a first material A including a fire-retardant additive and which has been incorporated into the belt structure in a first region thereof; and,
a second material B having a low, or no, content of a fire-retardant additive and being incorporated into the belt-structure in a second region thereof;
wherein the second region is subjected to a higher level of mechanical stress than the first region.

2. The belt as claimed in claim 1, wherein the quantitative proportions applicable to the first material A and the second material B are as follows:
first material A: from 40% by weight to 95% by weight
second material B: from 60% by weight to 5% by weight.

3. The belt as claimed in claim 2, wherein the quantitative proportions applicable to the first material A and the second material B are as follows:
first material A: from 60% by weight to 80% by weight
second material B: from 40% by weight to 20% by weight.

4. The belt as claimed in claim 1, wherein the fire-retardant additive is selected from the group consisting of melamine phosphate, melamine polyphosphate, melamine cyanurate, ammonium polyphosphate, a halogenated organic compound, an organic phosphoric ester, an organic phosphonate, red phosphorus, a metal hydroxide, a metal carbonate, glass powder, and quartz powder, or a mixture thereof.

5. The belt as claimed in claim 1, wherein the quantitative proportion of the fire-retardant additive for the first material A is from 5% by weight to 50% by weight.

6. The belt as claimed in claim 5, wherein the quantitative proportion of the fire-retardant additive for the first material A is from 10% by weight to 30% by weight.

7. The belt as claimed in claim 1, wherein the quantitative proportion of the fire-retardant additive for the second material B is from 0% by weight to 5% by weight.

8. The belt as claimed in claim 7, wherein the quantitative proportion of the fire-retardant additive for the second material B is from 0% by weight to 3% by weight.

9. The belt as claimed in claim 1, wherein the outer layer of the belt comprises the first region.

10. The belt as claimed in claim 1, wherein the substructure of the belt with the force-transmission zone comprises the second region.

11. The belt as claimed in claim 10, wherein the second material B has been incorporated in the substructure in such a way that the second region partially or completely sheaths the tension-member system.

12. The belt as claimed in claim 10, wherein the second material B has been incorporated in the substructure in such a way that the first region partially or completely sheaths the tension-member system.

13. The belt as claimed in claim 1, wherein the first material A forms the belt core and the second material B forms the belt shell.

14. The belt as claimed in claim 13, wherein the tension-member system has been embedded in the belt core with complete sheathing by the first region.

15. The belt as claimed in claim 13, wherein the belt shell completely surrounds the belt core.

16. The belt as claimed in claim 1, wherein the belt structure further comprises at least one embedded layer.

17. The belt as claimed in claim 16, wherein the embedded layer is composed of a textile material.

18. The belt as claimed in claim 16, wherein the embedded layer has been rendered fire-retardant.

19. The belt as claimed in claim 1, wherein the outer layer and/or the force-transmission zone also has/have a coating.

20. The belt as claimed in claim 19, wherein the coating for the outer layer and/or the force-transmission zone is a superposed textile.

21. The belt as claimed in claim 19, wherein the coating for the outer layer and/or the force-transmission zone has been rendered fire-retardant.

22. The belt as claimed in claim 1, wherein the belt is a flat belt, V-belt, V-ribbed belt or toothed belt, or a composite cable.

23. A tension element for elevator engineering comprising the belt according to claim 1.
